(19) United States
(12) Patent Application Publication
(10) Pub. No.: US 2006/0228271 A1
(43) Pub. Date: Oct. 12, 2006

(54) Porous metal honeycomb support of an automobile exhaust gas cleaning catalyst

(76) Inventors: Deming Zhang, Shanghai (CN); Shouliang Zhong, Shanghai (CN); Zhiwei Zhao, Shanghai (CN); Xianzhong Mingqiang Mao, Shanghai (CN); Youqian Tang, Shainghai (CN); Xuxi Xu, Zhejiang (CN)

Correspondence Address: RABIN & Berdo, PC, 1101 14TH STREET, NW, SUITE 500, WASHINGTON, DC, 20005, US

(21) Appl. No.: 10/549,500

(22) PCT Filed: Mar. 15, 2004
(86) PCT No.: PCT/CN04/00201

§ 371 Date: Sep. 14, 2005

(30) Foreign Application Priority Data
Mar. 14, 2003 (CN) 03229458.1

(51) Int. Cl. B01D 50/00

(52) U.S. Cl. 422/177

(57) ABSTRACT

This invention relates to a porous metallic honeycomb substrate for automotive exhaust gas cleaning catalysts. It is mainly a column substrate formed by sintering metal grains, with many connected fine pores between the metal grains. And there are also many through holes between the two end faces of the column. Because the sintered metal grains have constructed a rough surface, the noble metal catalysts can be coated firmly on the said porous metal honeycomb substrate and is not easy to be blown off by the vent gas. In addition, because there are many fine pores between the metal grains, the gas can contact with the catalysts effectively, and so the conversion efficiency can be improved greatly.

### DESCRIPTION

Porous metallic honeycomb substrate for automotive exhaust gas cleaning catalysts

### SCOPE

The subject invention is addressed to a substrate for automotive exhaust gas cleaning catalysts, particularly to a porous metallic honeycomb substrate for automotive exhaust gas cleaning catalysts.

### BACKGROUND

The harmful gases (CO, NOx, HC) in the automotive exhaust gas are the main pollution sources to the atmosphere, the situation in large cities is much worse. It is one of the effective ways to purify the automotive exhaust gas by converting the harmful gases to harmless gases. The exhaust gas cleaning catalysts are carrier type catalysts in which noble metal catalysts such as Platinum (Pt), Palladium(Pd) and Rhodium(Rh) are now commonly carried on the substrate as shown in FIG. 1.

At present there are 2 kind of materials for catalyst substrates used in industry: ceramics and metals. Some properties of ceramic materials will not be considered suitable for catalyst substrates. The ceramic substrate heats slowly due to its high heat capacity and low heat conductivity and its heat dissipation, resistance to mechanic and heat shock are very poor. Worse the all, the poisonous effect on the noble metal catalysts can be caused by the strong acid oxide SiO₂ containing in the ceramic substrates. Also, ceramic substrate will not give full play to the catalytic promoters because of its low electrical conductivity. We must increase the volume of ceramic substrate if we need to meet the requirement of emission control. On the other hand, metallic substrates for catalysts are usually used in the shape of honeycomb, which are made by curling and then welding metallic foils of heat resistant alloys into the proper shape. Compared with ceramic substrates, metallic substrates have many strong points such as their low heat capacity, rapid heating that is helpful for solving the pollution problem in the cold starting stage in automobiles, better conversion efficiency, smaller volume, high resistance to heat shock, low pressure loss and longer service life. However, the surfaces of metallic foil are smooth so that the catalytic coat would be easily blown off by exhaust gas. The hole-walls of metallic foil are dense and the holes of honeycomb are not connected. Consequently the exhaust gas can not flow through the walls such that the specific surface and gas-to-catalyst contact are not as satisfactory as expected. The conversion efficiency will not be as high as it should be.

### SUBSTANCE OF THE INVENTION

The invention is intended to circumvent such drawbacks of the conventional metallic honeycomb substrates as the coat easily peeled off and dissatisfactory conversion efficiency and thus we have developed a porous metallic honeycomb substrate for automotive exhaust gas cleaning catalysts to reach our aim.

In this connection, we worked out the following practical technical program: A column substrate was sintered from metal grains, usually of heat resistant alloys, with grain diameter of 5-80 μm, especially of 30-50 μm. There exist many micro-pores between metal grains and the pores are connected. The apparent density of the substrate is 0.5-2.0 g/cm³. There are many though-holes between the two end faces of the column and the number of holes is 200-600 per square inch (Cpi), especially 300-400 Cpi.

The porous metallic honeycomb substrate hereof, sintered from metal grains, possess rough surfaces of walls which are favorable to construct firm coat. It is difficult to blow the coat off by exhaust gas. Moreover, the micro-pores between the metal grains enhance the turbulent flow and increase the gas-to-catalyst interface so that the exhaust gas of automobiles can get the intimate contact with catalysts and accordingly the conversion efficiency can be improved greatly.

### DESCRIPTION OF DRAWINGS

FIG. 1 is simply a model of carrier type catalysts where shape 1 represents substrate, shape 2 represents noble metal catalysts such as Pt, Pd, Rh and shape 3 represents assistant catalysts or catalytic promoters;

FIG. 2 is a schematic solid figure of the invented porous metallic honeycomb substrate;

FIG. 3 schematically represents in magnified section the porous metallic honeycomb substrate in this invention.

FIG. 4 schematically represents in magnified section the metallic honeycomb substrate in present engineering practice.

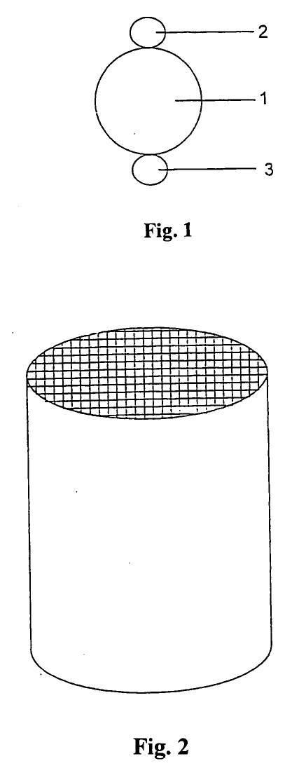

### EXAMPLES

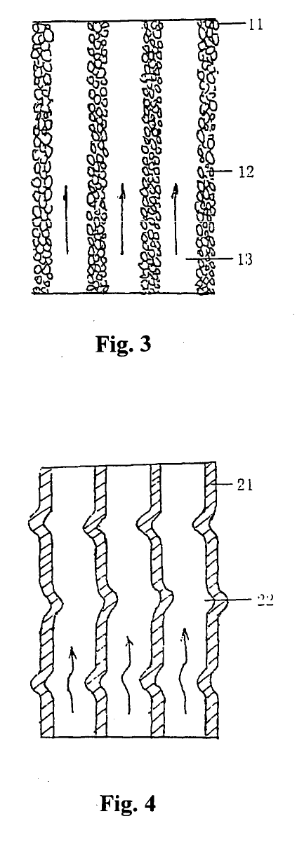

As shown in FIG. 3, a column substrate was sintered from metal grains (11 in FIG. 3) usually of Fe, Cr, Al with grain size of 20-80 μm, especially of 30-50 μm. There exist many micro-pores (12 in FIG. 3) between metal grains and the pores are connected. The apparent density of the substrate is 0.5-2.0 g/cm³. There are many though-holes (13 in FIG. 3) between the two end faces of the column and the number of holes is 300-500 per square inch (Cpi), especially 400 Cpi.

The above-mentioned porous metallic honeycomb substrate, after coated with noble metal catalysts, possesses rough surfaces of walls which accordingly produce firm coat, thus not easy to be blown off by exhaust gas. Moreover, the micro-pores between the metal grains enhance the turbulent flow and increase the gas-to-catalyst interface so that the exhaust gas of automobiles can get the intimate contact with catalysts and accordingly the conversion efficiency can be improved greatly. The lower heat capacity and better heat conductivity of porous metallic honeycomb substrate can decrease the pollution of exhaust gas in the cold starting stage of automobiles. We selected metals of Fe, Cr and Al to produce the honeycomb substrate because their electro negativity are lower than that of Pt, Pd and Rh and Fe, Cr and Al are not poisonous materials to noble metal catalysts but promoters to increase the catalytic activities and the conversion of harmful gases. As a consequence, the volume of the substrate and the amount of noble metals can be decreased to meet the same requirement of emission control and thus higher economical profit can be obtained. In addition, the selected metallic materials have such advantageous properties as high ductility, high resistance to corrosion and impact and much lasting mechanical strength.

To summarize, the porous metallic honeycomb substrates, which have much more advantages than general metallic honeycomb substrates, will certainly become the dominant substrates for automotive exhaust gas cleaning catalysts along with the social development and higher and higher environmental requirements.

We claim:

1. A porous metallic honeycomb substrate for automotive exhaust gas cleaning catalysts in which the substrate is a column sintered from metal grains and there are many connected micro-pores between the grains and many through-holes between the two end faces of the column.

2. A porous metallic honeycomb substrate for automotive exhaust gas cleaning catalysts as set forth in claim 1 in which metal grains are made of heat resistant alloys.

3. A porous metallic honeycomb substrate for automotive exhaust gas cleaning catalysts as set forth in claim 1 in which the diameter of metal grains is 5-80 μm.

4. A porous metallic honeycomb substrate for automotive exhaust gas cleaning catalysts as set forth in claim 1 in which the apparent density of the substrate is 0.5-2.0 g/cm³.

5. A porous metallic honeycomb substrate for automotive exhaust gas cleaning catalysts as set forth in claim 1 in which the number of through-holes in the column is 200-600 per square inch.

6. A porous metallic honeycomb substrate for automotive exhaust gas cleaning catalysts as set forth in claim 3 in which the diameter of metal grains is 30-50 μm

7. A porous metallic honeycomb substrate for automotive exhaust gas cleaning catalysts as set forth in claim 5 in which the number of through-holes in the column is 300-400 per square inch.
